(19) United States
(12) Patent Application Publication
(10) Pub. No.: US 2001/0037304 A1
(43) Pub. Date: Nov. 1, 2001

(54) Method of and apparatus for delivery of proprietary audio and visual works to purchaser electronic devices

(76) Inventor: Richard S. Paiz, North Miami Beach, FL (US)

Correspondence Address: GLENN GOLD, P.A., 1503 Silverleaf Oak Court, Palm Beach Gardens, FL, 33410, US

(21) Appl. No.: 09/819,174

(22) Filed: Mar. 27, 2001

Related U.S. Application Data
(60) Provisional application No. 60/193,160, filed on Mar. 28, 2000.

(51) Int. Cl. G06F 17/60

(52) U.S. Cl. 705/52; 705/57; 705/59

(57) ABSTRACT

A method of delivering audio and audio visual works to users of computer terminals includes the steps of: providing a data warehouse of digitized works; providing program means for end user computers to access, select and play at least one of the works; providing means for controlling end user access to the works and for collecting payment for playing at least one of the works; and diverting a portion of the payment for playing the at least one work to the holder of a copyright to the at least one work. The method preferably includes the additional steps of encrypting the works; and providing the end user with program means for deciphering the works. The method still further preferably includes additional the steps of delivering advertising matter to the end user with each work the end user selects and plays; keeping a record of the particular works each end user selects and plays; customizing advertising delivered to the end user to fit within any pattern of work selection by the particular end user. An apparatus for performing the method is also provided, including a computer hive made up of several inter-linked computers having specialized functions, the computers operating in unison to build a supercomputer that has shared disk space and memory, in which each node belongs to the collective and possesses its own business rules and membership to an organization managerial hierarchy.

### BACKGROUND OF THE INVENTION

1. Field of the Invention

The present invention relates generally to the field of distribution of musical and video works to ultimate purchasers. More specifically the present invention relates to a method and apparatus for controlled delivery of proprietary sound recordings and moving pictures by a supplier to subscriber computer terminals, in a manner enabling subscriber access to be monitored and controlled such that copyright holders of the delivered works automatically receive royalties to which they are legally entitled each time a respective song, music video or movie is played by a subscribing end user.

2. Description of the Prior Art

With the proliferation of the Internet there have been myriad corresponding benefits, not the least of which has been the improved ease with which information can be accessed and distributed by individuals throughout the world. Unfortunately, the rapid growth of the Internet has outpaced the development of technologies to enable authors of copyrighted works to monitor and control unauthorized usage, such as copying and distribution, of their works.

For example, one Internet site, Napster.com, gained notoriety for enabling visitors to access and play copyrighted music and audio-video works on the web, delivering these copyright protected works to anyone free of charge, thereby enabling users to play and copy works while avoiding payment of royalties to the rightful copyright owner. Napster does not deliver works to end users, instead providing software enabling users to access an computer chat room environment in which Napster subscribers can freely exchange copies of musical works in a downloadable format. In particular, Napster subscribers simply scan the chat room for other subscribers also logged on to the site and having a particular desired musical work. Subsequently, the desired work can be easily downloaded. Supporters of the site believe that by merely providing an environment for facilitating the exchange of files between subscribers to the site, Napster does not violate federal copyright statutes and laws. Others take the position that Napster is in direct violation of federal copyright laws by facilitating copyright infringement by its member subscribers. In any event, this indirect delivery method places the ordinary requirement for payment in a legal gray area and thereby thwarts the spirit of fairness embodied in the copyright laws of the United States and in the international Berne Convention.

Accordingly, it would be desirable to provide a method for delivering proprietary audio and audio-visual works to end users while assuring that copyright royalties are paid to the rightful copyright holder for each playing of the work, thereby precluding users from the unlawful infringement of copyrighted works.

### SUMMARY OF THE INVENTION

It is an object of the present invention to provide a method and apparatus for protecting copyright owners from what is commonly referred to as “rip”, that is, the avoidance of royalty payments by users to copyright owners.

It is another object of the present invention to provide such a method which also protects the subscriber from the disclosure of personal subscriber information and song and video selection information, to a corporate or other entity for uses not authorized by the subscriber, such as marketing.

It is still another object of the present invention to provide such a method which financially supports the supplier of the works by collecting subscription and renewal fees from the end users and by collecting advertiser fees for advertisements played for end users together with the requested works.

It is yet another object of the present invention to provide such a method which automatically gathers marketing information about subscribers by noting the particular works selected for playing by each subscriber.

It is a further object of the present invention to provide such a method which assist subscribers in evaluating works prior to making a purchase of such works, either in the form of a portable data storage medium, such as a compact disk, digital video disk or video tape, or through the digital transfer of such information over a network for downloading to a user device.

The present invention accomplishes the above-stated objectives, as well as others, as may be determined by a fair reading and interpretation of the entire specification.

A method of delivering audio and audio visual works to users of computer terminals is provided, including the steps of: providing at least one data warehouse of digitized works; providing program means for end user computers to access, select and play at least one of the works from the data warehouse; providing means for controlling end user access to the works and for collecting payment for playing at least one of the works; and diverting a portion of the payment for playing a work to the respective copyright holder or owner.

In a further aspect of the present invention, the method includes the additional steps of encrypting the works; and providing the end user with program means for decrypting the works.

In yet a further aspect of the invention, the method includes the additional steps of delivering advertising matter to the end user along with a selected and played work; keeping a record of the particular works each end user selects and plays; and customizing advertising delivered to the end user to fit within any pattern of work selection by the particular end user.

An apparatus for performing the method is also provided, including a computer hive made up of a plurality of inter-linked computer devices having specialized functions, the computers operating in unison to create a supercomputer having shared disk space and memory, in which each node belongs to the collective and possesses its own business rules and membership to an organization managerial hierarchy.

The computer hive preferably includes multiple tiers of computer clusters, including: (1) a software tier in which each subscriber has its' own unique club member identification which is unique to the hive; (2) an IP tier in which multiple IP servers allocate resources to the end users to enable the end users to receive live music and to interact in a virtual environment; and (3) a billing and control tier through which the computer hive validates requests, performs live billing, and controls of all of the interactions the subscribers receive. The billing and control as tier preferably includes a plurality of collective members and a single server controller. Each IP server hosts paying demographic blocks of end users having a common interest in music, movies, or some other form of audio or video entertainment. For example, an IP server can host a block of end users sharing a common interest in a particular music group, such as Metallica. Each block of end users receives a live feed of a radio broadcast from a disk jockey and/or individualized selections from a virtual maestro or movie director, such as Beethoven or Mozart. The billing and control tier is also responsible for providing on-demand resources to each end user.

Delivery can be accomplished by forwarding licensed works on physical data storage media such as compact disks (CDs), digital video disks (DVDs) and the like. Alternatively, delivery can be accomplished by the transfer of digitized files containing the works over a communications network such as, for example, the Internet, to a subscriber device.

A data warehouse of digitized music and video works is created and maintained on either one of the aforementioned physical data storage media or, alternatively, on the Web. The end user initiates a subscription, thereby becoming a subscriber, by obtaining software designed particularly for use with the present invention from the supplier and installing the software on the user's computer, or other receiving device, to enable and facilitate access to the data warehouse. The software can be obtained through the purchase of a licensed version, or downloading a freeware version. The subscriber pays a periodic subscription fee to the supplier and also pays for each work he or she selects and plays, based upon a previously agreed upon plan with the supplier.

In a further aspect of the present invention, the subscriber also supplies certain personal information to the supplier for marketing and advertising purposes, and a credit or debit card account identifier for subscriber billing. A portion of the fee collected from the subscriber for playing a work is paid to the copyright holder of the work. Furthermore, the supplier can collect additional revenues through delivery of advertising segments to a subscriber listening/viewing device, such as a computer monitor and speakers, wireless device interface, or other comparable device. Preferably, the aforementioned advertisements run just prior to playing of the work. The choice of works selected by a particular subscriber can be recorded and stored for marketing purposes. For example, this information can be used for target marketing, wherein custom advertising is provided during playing of subsequently selected works.

### BRIEF DESCRIPTION OF THE DRAWINGS

Various other objects, advantages, and features of the invention will become apparent to those skilled in the art from the following discussion taken in conjunction with the following drawings, in which:

FIG. 1 is a schematic representation or block diagram generally illustrating a multi-tiered computer hive architecture for executing the inventive method of proprietary musical work delivery to end user computer devices, in accordance with the present invention

FIG. 2 is a schematic representation or block diagram of a multi-tiered computer hive architecture for delivering video works to end user computer devices, wherein the first tier is grouped by geographic location, the second tier is grouped by video type and the third tier is grouped by media network and commercial sponsor, in accordance with another aspect of the present invention;

FIG. 3 is a schematic representation or block diagram of a multi-tiered computer hive architecture for delivering musical works to end user computer devices, in accordance with an aspect of the present invention, wherein the first tier is grouped by geographic location, the second tier is grouped by music type, and the third tier is grouped by record label and commercial sponsor;

FIG. 4 is a flow chart illustrating a preferred royalty payment scheme, in accordance with the present invention;

FIG. 5 is a schematic representation of a preferred system architecture, illustrating the information gathering function of the present invention in a virtual environment, wherein the gathered information pertains to financial transactions, advertisement patterns, and music or movie picture usage;

FIG. 6 is a schematic representation of a system network architecture incorporating independent groups of computer servers for supporting the delivery of both music and movie selections, in accordance with a preferred embodiment of the invention.

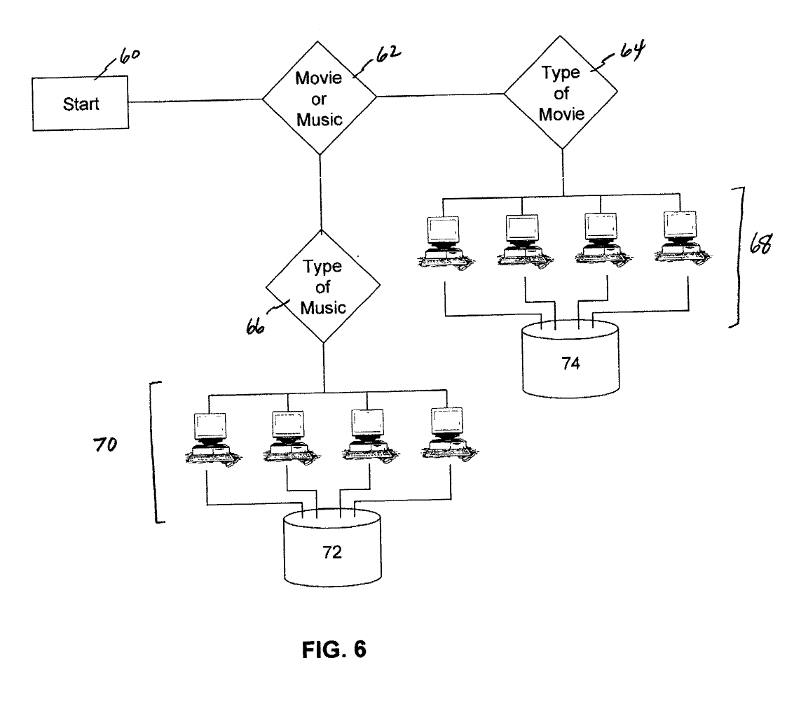

### DETAILED DESCRIPTION OF THE PREFERRED EMBODIMENTS

As required, detailed embodiments of the present invention are disclosed herein; however, it is to be understood that the disclosed embodiments are merely exemplary of the invention which may be embodied in various forms. Therefore, specific structural and functional details disclosed herein are not intended to be interpreted as limiting, but merely as a basis for the claims and as a representative basis for teaching one skilled in the art to variously employ the present invention in virtually any appropriately detailed structure.

Reference is now made to the drawings, wherein like characteristics and features of the present invention shown in the various FIGURES are designated by the same reference numerals.

### First Preferred Method

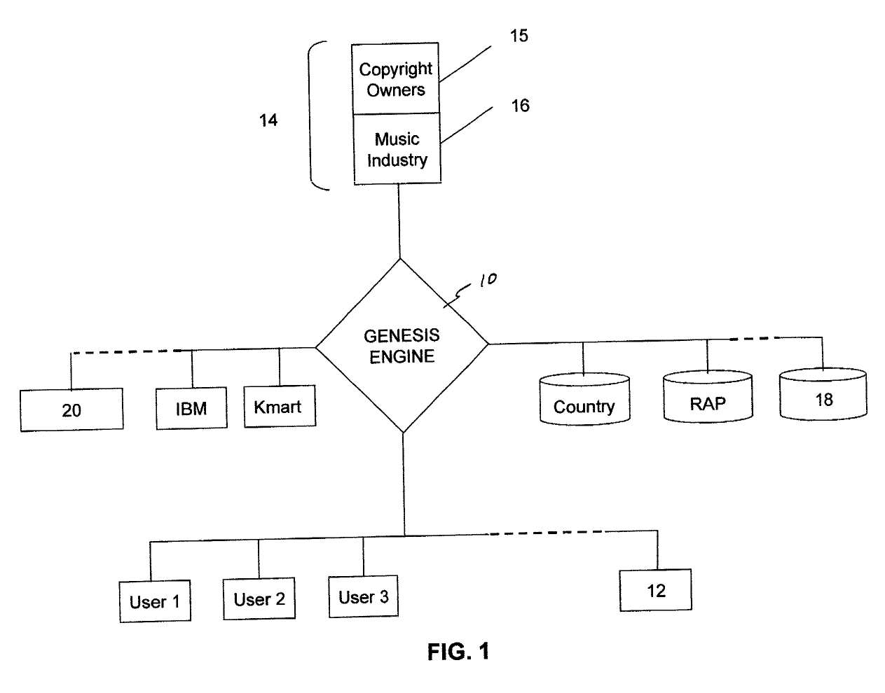

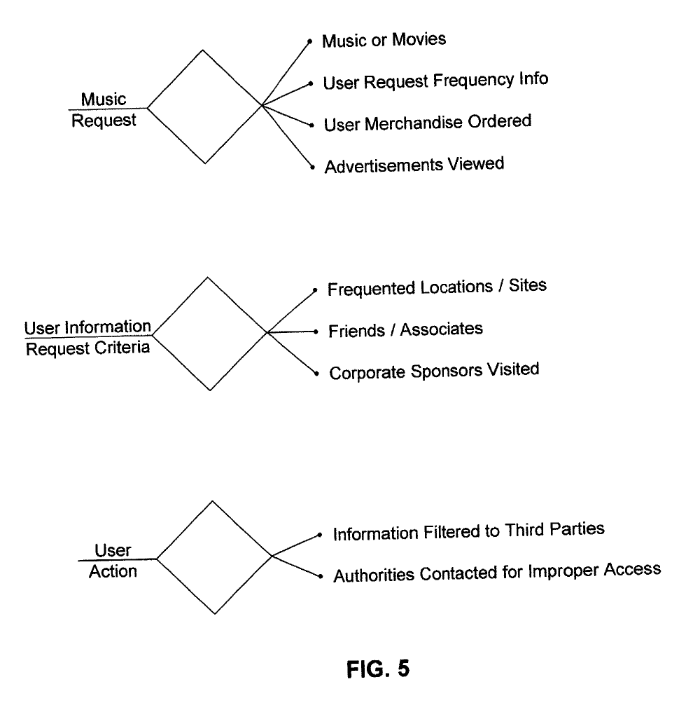

Referring to FIGS. 1-5, a method of controlled delivery of proprietary sound recordings and moving pictures by a supplier to a subscriber device is disclosed. While specific subscriber device types, such as a personal computer, may be referred to throughout the specification it will be apparent to those skilled in the art that the invention is not intended to be so limiting. In particular, the term “subscriber device” is intended to incorporate any device, either in existence or available in the future, with which the present invention can be practiced. By way of example, such subscriber devices can include computer terminals, hand held wireless devices and cable television, to name just a few.

Delivery can be accomplished through delivered physical data storage media or by the transfer of one or computer files via the World Wide Web (hereinafter the Web). While we prefer the use of compact disks, it will be apparent to those skilled in the art that the type of data storage medium can be varied without departing from the scope of the present invention. The method operates in a manner ensuring that subscriber access is monitored and controlled such that copyright holders of the delivered works receive royalties legally due them for each playing of a song, music video or movie by an end user subscriber, as well as any additional fee the system may elect to pay the copyright holders as a revenue enhancing function.

At least one data warehouse 18 of digitized musical and/or video works is created and stored on a physical data storage medium, such as a compact disk, or on the Web. The end user 12 becomes a subscriber by purchasing from the supplier and installing a computer program permitting and facilitating access to the data warehouse. The program can be incorporated into the compact disks containing the works. The subscriber preferably pays a periodic subscription fee to the supplier and also pays for each work he or she selects and plays. The subscriber also supplies certain personal information about himself or herself to the supplier for use in marketing, and a credit or debit card number for use in subscriber billing.

To interact with the system, the subscriber inserts the compact disk into the appropriate driver of his or her computer or, alternatively, commences communication with the supplier website. The subscriber logs onto the system and selects and requests a certain work in the data warehouse from a list provided by the supplier for either playing or purchasing the work. Upon requesting access, a subscriber pays to either play or purchase a work by exchanging system credits, earned as described below, or by automatic system billing to his or her debit/credit card. In the latter case, the subscriber credit or debit card is automatically debited.

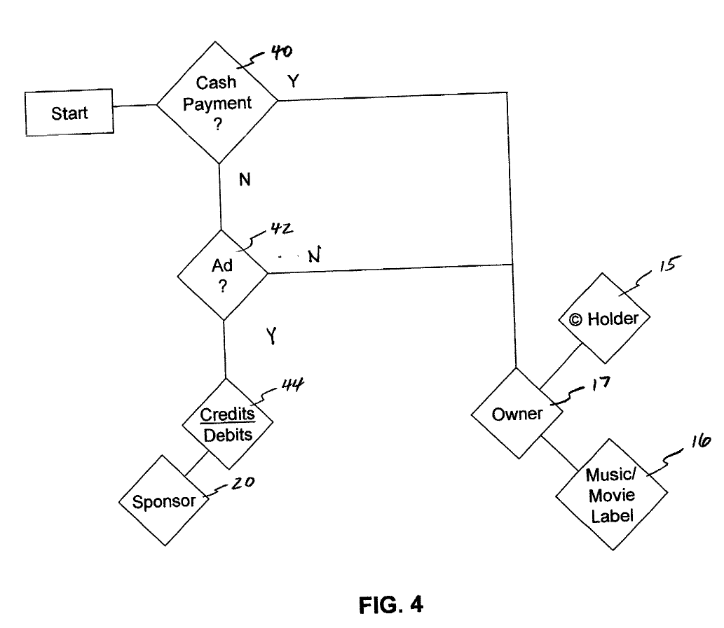

As best illustrated in FIG. 4, where payment is made in cash, the cash payment 40 is divided between the copyright holder 15, the system owner 17 and the music or movie label 16. If payment is made by credits accumulated through receiving advertisements, payment is made to the sponsoring entity 20.

If the subscriber elects to simply play a work, the work is played through the subscriber computer such that the musical work is audible to the subscriber through the computer speakers, or such that a moving picture audio-visual work video portion is visible to the subscriber on the computer monitor and the audio portion is audible to the subscriber through the computer speakers. The subscriber can stop the play of the work at any point and resume at any later time. The subscriber can immediately select the same work again and pay the same fee, or in some instances a reduced access fee, for the second or subsequent playing of the work. If purchasing of the work is selected, the work is burned onto a subscriber CD.

All prices for playing or purchasing works through the system are preferably expressed in system credits. The prices can vary work-to-work, just as the purchase price for CD's in music stores vary. In most instances, of course, the latest works by the most popular artists command the highest prices while older and lesser known works may be offered at reduced, nominal or no charge. A subscriber may purchase a work, rather than merely have it played, by paying the system credit price to purchase and burn the work onto a CD. The system optionally scans the CD after burning to assure that it is readable. Alternatively, the subscriber can purchase a work from an outside source. In either case, the subscriber can register the purchase of the work with the system, and any subsequent playing of the work through the system, at no charge, since modern copyright law permits a purchaser of a copy of a work to play the work at any time and as often as desired without further payment.

A subscriber 12 earns and accumulates system credits by agreeing to receive and play an advertising campaign offered by a particular advertiser or sponsor 20. Preferably, when the subscriber purchases the system software, he or she joins a particular advertiser plan. By way of example, Company A may offer X credits for playing its particular advertising campaign, while Company B may offer Y credits for a lesser or a more extensive campaign. The particular advertising campaigns offered to a subscriber are limited to the advertising to which the particular subscriber is believed to be receptive and potentially interested in view of his or her profile maintained by the system. For instance, an elderly bachelor might choose to receive investment firm advertising rather than child care or feminine hygiene product advertising.

This customized delivery of targeted advertising campaigns to specific subscribers increases the value of the campaigns to the advertiser. In turn, the advertiser is more likely to pay a premium for the system medium and format to the system suppliers. There may be advertising for new releases of or concert tickets for recording artists known to have been selected for play by the particular subscriber. For example, such advertising can be in the form of video clips. The new releases, of course, as well as concert tickets, can be paid for with system credits. The system receives funding to sustain itself from advertiser revenue, sales of works burned onto CD's by subscribers, and direct subscriber payments for the operating programming. A portion of the fee collected from the subscriber for playing the work is automatically placed in escrow for the copyright holder of the work or, alternatively, wired directly to his or her account. On the other hand, if the subscriber payment is in the form of system credits, the fee due the copyright holder is either paid from an advertising revenue fund, since the subscriber compensated the system through listening to advertising, or from system revenues. In this way, the copyright holder is assured of receiving the royalties legally due him or her, and the letter and spirit of intellectual property law is upheld, unlike with the notorious delivery methods of existing systems.

The supplier gains additional revenues through delivery of advertising segments on the computer speakers or on the computer monitor of the users, as applicable and these ads preferably run just prior to playing of the work. This method of advertising delivery is similar to the placement of movie trailers at the beginning of pre-recorded movie videotapes. Alternatively, advertising can be presented in pop-up form on subscriber monitors during the playing of the work. The selection of works by each subscriber is recorded and stored for marketing purposes and for automatic selection of works for the subscriber, such as by a virtual maestro as described below. This information is used in part to customize the advertising displayed for the particular subscriber during playing of subsequently selected works. One such form of customized advertising is song or video previews which seem to fit within the established and individualized pattern of individual subscriber access. The accessed and played works also help a subscriber decide whether to purchase a compact disk or audio tape of a musical selection, or a digital video disk or video tape of a movie or music video. Such purchase is optionally offered through the supplier. In this way the system boosts rather than competes with compact disk and video sales.

The system can also be structured to detect and prevent fraud. The subscriber identification and selected work identification can be mapped to the individual subscriber accessing the work. This form of access monitoring would aid law enforcement in fraud investigations.

### First Preferred Embodiment of Apparatus for Performing Method

The physical structure of the system is preferably as follows. Several inter-linked computers are provided having specialized functions, collectively referred to as a hive, and referred to commercially as the Genesis Engine 10. The Genesis Engine consists of multiple clustered computers that operate in unison using Beowulf and Hoard technology to build a supercomputer that has shared disk space and memory. Each node belongs to the collective and possesses its own business rules and membership to an organization managerial hierarchy.

The system is made up of computers linked into a neural network which continuously scans and gathers information from, understands and interacts with an environment. The system further consolidates its resources to automatically optimize certain parameters in real time, such as to minimize cost, to shunt functions from computers within the network operating at or near capacity and thus having smaller buffers to other computers having larger buffers to maximize efficiency, and to continuously test and optimize selections offered to a human user.

The system is provided within a virtual environment, including several computers which are networked to each other to function as a single unit, including at least one parent computer synchronizing and delegating tasks among the several computers, so that the unit scans and gathers data from the virtual environment, and processes and organizes the data into an implementable representation of the data. The unit preferably additionally includes at least one dedicated computer for performing a specific task, and at least one processing computer for providing processing power to the unit.

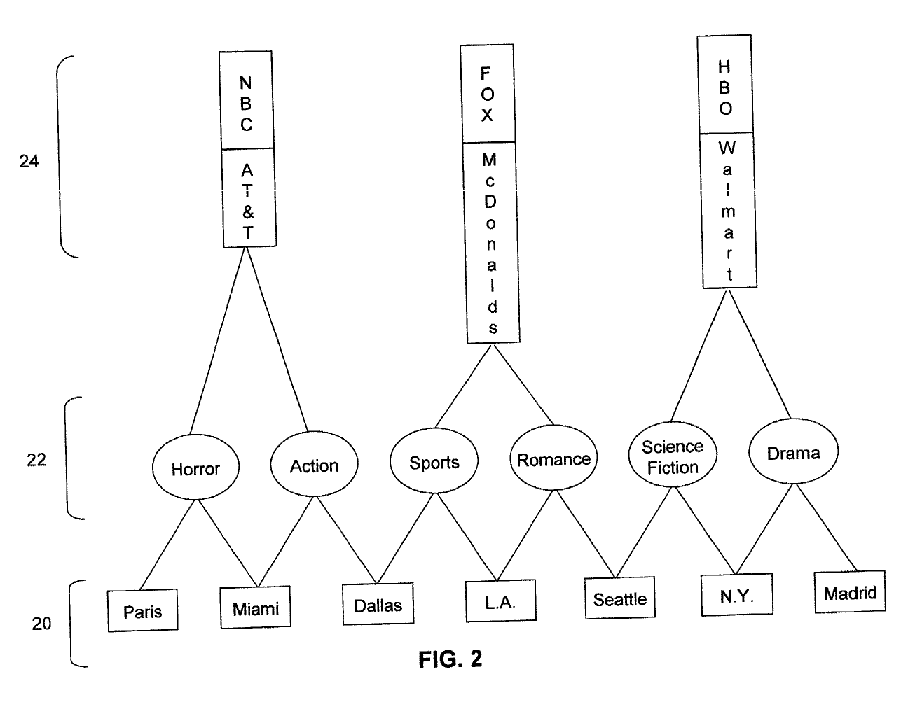

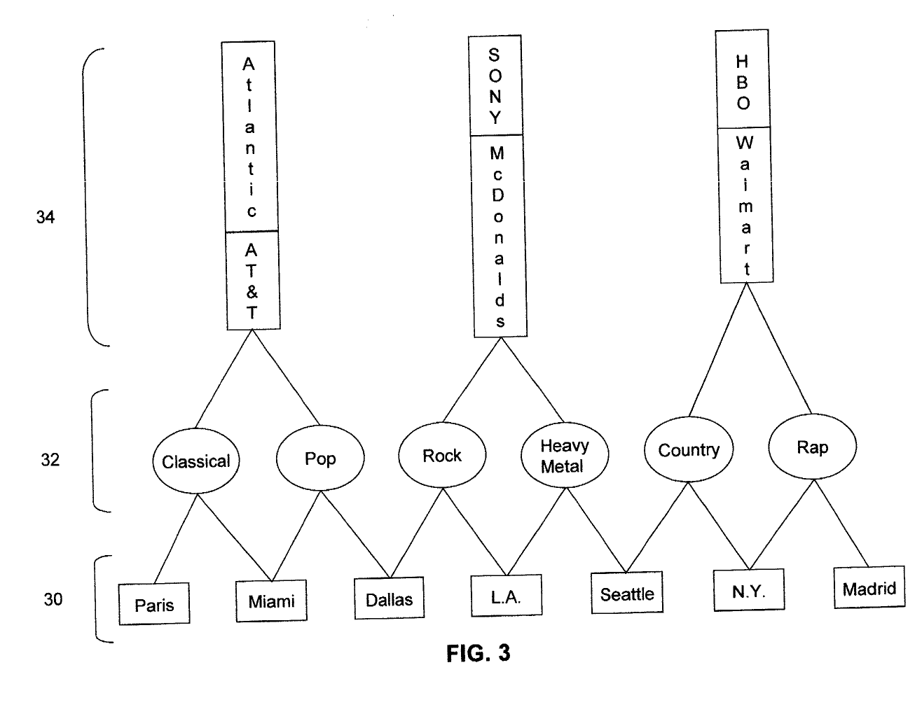

As best depicted in FIGS. 2 and 3, the first tier of computers 20, 30 are grouped by geographic location, the second tier of computers 22, 32 are grouped by music or movie type, and the third tier are grouped by media network or label and commercial sponsor 24, 34. The third tier does data mining, actual advertising and editing.

The Genesis Engine for the music field consists of three tiers of computer clusters: (1) A Software Tier in which each subscriber has its own unique club member identification or “ID”, which is unique to the hive and used during connection by modem, DSL, wireless communication interface and the like; (2) An IP Tier in which several IP servers, preferably residing on a Sonnet ring, allocate resources to the end users so that they can receive live music and interact in a virtual environment while maximizing bandwidth; and (3) The Billing and Control Tier in which the Genesis Engine validates requests, performs live billing, and controls of all of the interactions the subscribers receive.

The production Genesis Engine Billing and Control Tier consists of multiple collective members and one server controller. Each IP Server hosts demographic blocks of end users who receive a live feed of radio broadcast. These servers are responsible for providing on demand resources to each club member/subscriber. The Genesis Engine approves each request and places the request in a wait line queue to determine the best method to deliver the resources with the measured available bandwidth.

Each club member receives access and operational programming on a set of compact disk CD diskettes designating a specific category or categories of music and predefined advertisements customized to the particular subscriber. These programs have their own artificial intelligence and possess the subscriber credit card information in an encrypted format so that the subscriber can make immediate request: on the fly. When a credit card number is registered, the user places a specific password to determine authenticity.

The software creates a live session and/or virtual reality representation of a concert hall where the subscriber is able to interact in a virtual world. A disk jockey is provided who will select works for play for the demographic blocks of subscribers, and emphasize particular works for which the system owners have play quota contracts. A virtual maestro is also provided to make individualized selections for the subscriber.

The disk jockey is a real person who plays songs for a mass audience of subscribers, in the same way that a radio disk jockey selects and plays songs for broadcast. The disk jockey is preferably made available to subscribers in a virtual chat room so that a certain number of the mass audience can communicate with him directly.

The virtual maestro is a product of artificial intelligence, since it would be impractical to provide a real person to process personal selections for each and every subscriber. The virtual maestro is represented by a virtual image, either of Beethoven or Mozart, in the virtual concert hall and will play specific song or video requests of an individual subscriber, on a pay per view basis. Alternatively, the maestro will select a series of songs of videos according to the profile stored for the individual subscriber. The profile is assembled from information the subscriber provides to become a subscriber and from a history of selections made by the subscriber through the system, and the profile is in effect how the particular subscriber is clothed in the virtual world. The payments by the subscriber for selections through the maestro are higher than for selections played for a mass of subscribers by the disk jockey, because the maestro selections are made for the particular individual.

The maestro can also select and play televised or radio broadcast sports events selected by the individual subscriber, These events are stored in the system memory as they are broadcast from their source, so that the subscriber has the option of having a time delay introduced. As a result, a subscriber who arrives home after a sporting event, concert or other live or pre-recorded event has begun to be shown can elect to have his playing of the event start from the beginning of the event.

The subscriber alternatively can select works of play directly, one at a time. The virtual world contains different facilities to sell different types of merchandise to the subscriber. Furthermore it shows how many times each recording artist music the subscriber has played and generates a billing entity for each occurrence and then pays the appropriate royalties. In this way the system becomes the new watch dog of the music industry.

Access to the works is denied to non-subscribers by encrypting the works, such as by breaking the works into several segments and placing the segments out of sequence. An updated version of the program is delivered to each subscriber when he or she subscribes and when he or she renews the subscription, and whenever a current subscriber logs onto the system. In the latter instance, the subscriber is notified that a program update is to be downloaded such as through zip files. The updated version of the program deciphers each requested work by placing it back into its intended sequence before or as it is played on the user terminal. The encrypting prevents subscribers from burning works onto CDs which have only been provided for playing.

While the invention has been described, disclosed, illustrated and shown in various terms or certain embodiments or modifications which it has assumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

I claim:

1. A computer network system within a virtual environment for delivery of works of authorship to subscribers in exchange for payment, comprising:
a plurality of computers networked to one another in a hierarchy to function as a single unit, said hierarchy including a first tier having at least one parent computer performing subscriber billing tasks and synchronizing and delegating tasks among said plurality of computers, a second tier including at least one server computer allocating network resources to maximize bandwidth and direct selected works to subscribers requesting the works, and a third tier including a plurality of subscriber computers, each subscriber computer having system programming containing individual subscriber identification means and work accessing means.

2. The system of claim 1, wherein said work accessing means comprises at least one of a live session and a virtual reality representation of a site, and an interactive accessing procedure.

3. The system of claim 2, wherein said site is a concert hall.

4. The system of claim 2, wherein said interactive accessing procedure comprises interacting with a virtual disk jockey.

5. The system of claim 1, wherein said system programming individual subscriber identification means further comprises a subscriber credit or debit card number used to pay for accessed works.

6. The system of claim 1, wherein said system programming further comprises work encrypting means preventing downloading of said works.

7. The system of claim 6, further comprising decrypting means for decrypting of works to enable downloading of the works by subscribers who have paid to purchase said works.

8. The system of claim 1, further comprising a real-time login procedure, and request and reply mechanisms for validating each activity and transaction.

9. A computer network system within a virtual environment for delivery of works of authorship to subscribers in exchange for payment, comprising:
a plurality of computers networked to one another to function as a single unit, said plurality of computers including at least one parent computer synchronizing and delegating tasks among said plurality of computers, at least one server computer allocating network resources to maximize bandwidth and direct selected works to subscribers requesting the works; and
a plurality of subscriber computers, each subscriber computer having system programming containing individual subscriber identification means and work accessing means.

10. The system of claim, wherein said plurality of computers are arranged to create a hierarchy having multiple computer tiers.

11. A method of providing accessing works of authorship through a computer network system within a virtual environment for subscribers in exchange for payment, the computer network system comprising a plurality of computers networked to one another to function as a single unit, said plurality of computers including at least one parent computer synchronizing and delegating tasks among said plurality of computers at least one server computer allocating network resources to maximize bandwidth and direct selected works to subscribers requesting the works and a data warehouse; and a plurality of subscriber computers each having system programming containing individual subscriber identification means and work accessing means; the method comprising the steps of:
loading system programming, said system programming for subsequent loading into an individual subscriber computer;
logging onto said system and entering the world wide web;
requesting a particular work from said system for use on the individual subscriber computer;
making payment to the system for use of the certain work through the system; and
directing payment for the use of the certain work to the copyright holder.

12. The method of claim 11, further comprising the steps of creating a personal profile of each individual subscriber, and enhancing the personal profile with a continuously updated record of particular works and categories of works accessed by each subscriber.

13. The method of claim 12, further comprising the step of providing system credits for subscribers to earn and pay for use of said works.

14. The method of claim 13, further comprising the step of providing means for enabling payment for use of works with said system credits.

15. The method of claim 14, further comprising the steps of providing means for earning system credits by electing to receive and then playing advertising on an individual subscriber computer.

16. The method of claim 15, wherein the advertising comprises a company advertising campaign selected for the particular subscriber based upon the contents of the profile of the individual subscriber.

17. The method of claim 15, wherein the advertising comprises advertising for a particular artist selected for the particular subscriber according to the contents of the profile of the individual subscriber.

18. The method of claim 12, further comprising the step of providing a virtual reality web site for enabling access to works, the web site including a virtual concert hall containing a representation of a virtual disk jockey, the disk jockey comprising a live person playing a series of works for a group of subscribers.

19. The method of claim 12, further comprising the step of selecting a plurality of works, via said system, for playing in sequence for an individual subscriber based upon the contents of the profile of an individual advertiser.

20. The method of claim 12, further comprising the step of providing a virtual reality site for accessing works including a virtual concert hall containing a representation of an interactive virtual maestro, said interactive virtual maestro produced using artificial intelligence and playing works selected by an individual subscriber.

21. The method of claim 12, further comprising the step of delivering a set of works for play for the individual subscriber based upon an advertiser campaign and upon a subscriber profile, said works delivered via a digital medium of said system.

22. The method of claim 12, further comprising the step of delivering at least one work to be played for an individual subscriber, said at least one work selected to promote the specific works of a copyright holder, said works delivered via a digital medium of said system.

23. The method of claim 12, further comprising the step of receiving information directly from a subscriber for use in promoting and maximizing sales of works of a particular copyright holder.
